(19) United States
(12) Patent Application Publication
(10) Pub. No.: US 2012/0103036 A1
(43) Pub. Date: May 3, 2012

(54) Lock Enclosure

(75) Inventors: Sergio Meza, Lyons, IL (US); Matthew Johnson, (US)

(73) Assignee: FOLDING GUARD CORPORATION, Bedford Park, IL (US)

(21) Appl. No.: 12/916,517

(22) Filed: Oct. 30, 2010

(51) Int. Cl. E05B 9/06

(52) U.S. Cl. 70/448

(57) ABSTRACT

An enclosure for a lock mortise has parallel opposing side panels, parallel opposing upper and lower panels, a rear panel, and a forward opening for receiving the lock mortise. The panels are made of a suitable metal. Where the edges of two panels intersect, a tab is provided along the edge of one panel and a notch is provided along the edge of the intersecting panel wherein the tab of the first panel is received in the notch of the second panel.

The present invention relates to lock enclosures, and in particular to a sealed enclosure to protect the workings of the lock mortise against contaminants and tampering.

### BACKGROUND OF THE INVENTION

It is often desirable to section off portions of the workplace that may contain dangerous equipment, expensive equipment, or sensitive equipment that is easily damaged. Protective barriers and enclosures are also used to section off portions of a work space that may expose the individual to unusual or unexpected dangers, such as high electrical voltage, liquefied gasses, and radiation. It is desirable that the partitions for sectioning off protected areas be attractive in appearance, easy to assemble, rigid, and difficult to compromise.

An important part of such partitions is the provision of a gate allowing access to and from protected areas, and a lock for locking the gate. The lock must have sufficient strength such that it will not fail when subjected to tampering or brute force. The lock assembly must also have a sufficiently long life expectancy to survive for many years.

Locksets are generally either a hook latch, in which a hook is extended from the mortise as the latch is operated with the hook engaging a bar on a receiver. Such hook latches are particularly desirable for sliding doors and gates where the hook retains the sliding member from being withdrawn from the receiver. Alternately, a lockset may include a slam latch, such as a deadbolt in which an elongate member extends from the mortise and is received in a transverse opening in the receiver. Such slam latches are particularly desirable for swinging doors and gates in which the transverse opening retains the slam latch, or deadbolt, to prevent the gate or door from swinging.

Lock mortises having the physical strength to retain such gates are readily available in the art; however, such locks must be suitably mounted if they are to withstand outside contaminants, tampering, and brute force to which such locks are inevitably subjected. Accordingly, there is a need for an enclosure that will suitably retain a lock mortise, and yet will provide an attractive exterior.

### BRIEF DESCRIPTION OF THE INVENTION

Briefly, the present invention is embodied in a rectangular enclosure formed from two metal panels, each of which has a central panel portion and two end panel portions with a fold between the central panel portion and each of the end panel portions. Each of the two panels is folded ninety degrees at the folds to form a “C” configuration. Where the edges of two panels intersect, a tab is provided along the edge of one panel and a notch is provided along the edge of the intersecting panel wherein the tab of the first panel is received in the notch of the second panel and the weld extends around the intersection of the tab in the notch.

### BRIEF DESCRIPTION OF THE DRAWINGS

A better understanding of the invention will be had after a reading of the following detailed description taken in conjunction with the drawings wherein:

FIG. 1 depicts a barrier having a gate with a lock in an enclosure in accordance with the present invention;

FIG. 2 is an isometric view of a mortise enclosure in accordance with the present invention;

FIG. 3 is a front view of the enclosure shown in FIG. 2;

FIG. 4 is a planned view of a panel suitable for forming three of the surfaces of the enclosure shown in FIG. 2;

FIG. 5 is an isometric view of the panel shown in FIG. 4 folded along fold lines to form three surfaces of the enclosure shown in FIG. 2;

FIG. 6 is a plan view of a second panel suitable for forming three surfaces of the enclosure shown in FIG. 2;

FIG. 7 is an isometric view of the panel shown in FIG. 6 folded along fold lines to form three surfaces of the enclosure shown in FIG. 2;

FIG. 8 is a plan view of one of the two retaining tabs required to hold a mortise into the enclosure shown in FIG. 2;

FIG. 9 is an isometric view of the tab shown in FIG. 8; and

FIG. 10 is an exploded view of the enclosure shown in FIG. 2 with its associated lock mortise and lock cylinder.

### DETAILED DESCRIPTION OF PREFERRED EMBODIMENT

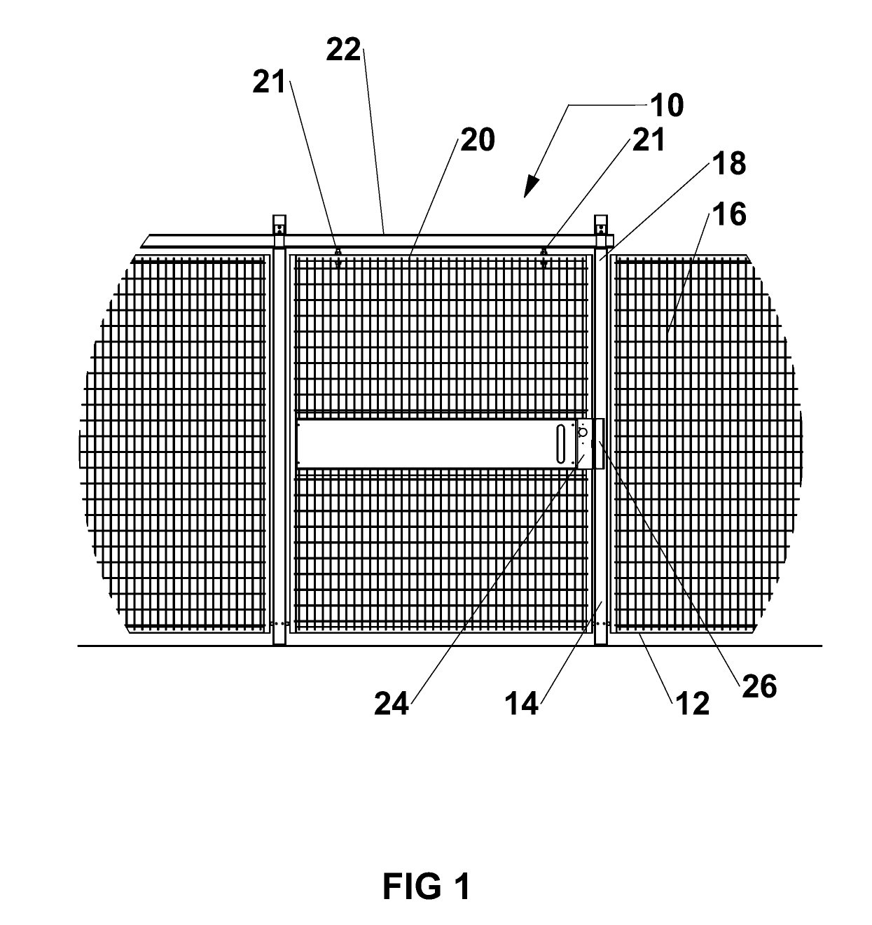

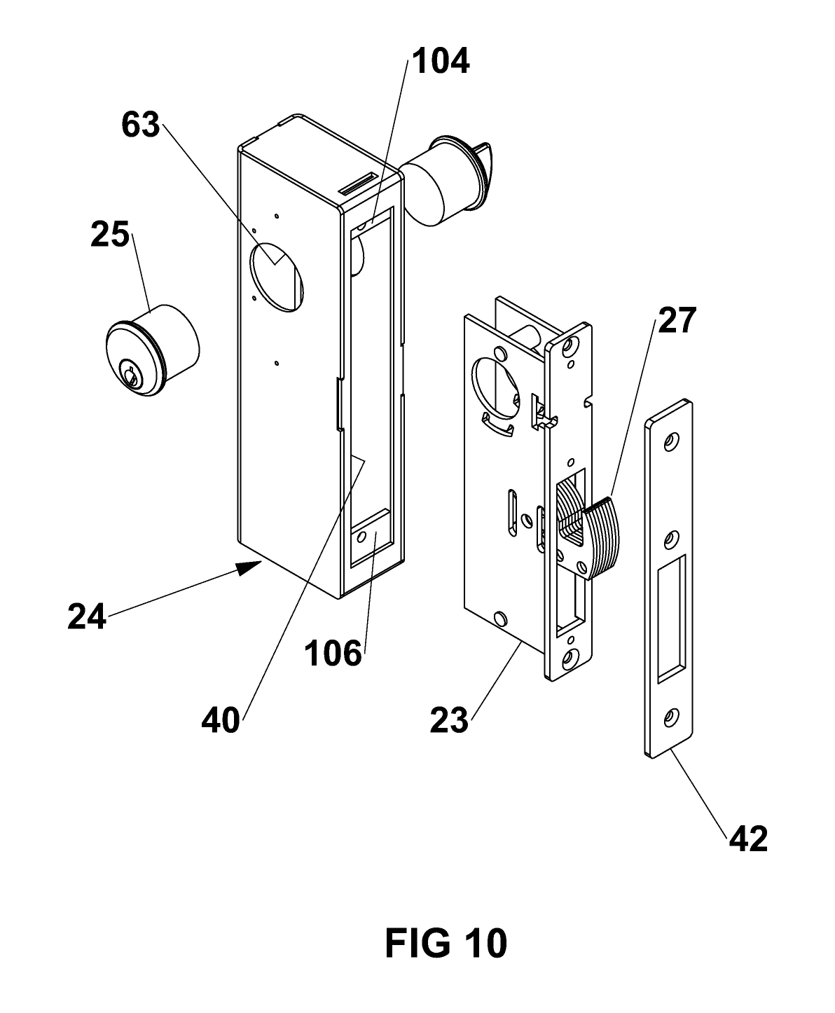

Referring to FIGS. 1 and 10, a protective barrier 10 for sectioning off a portion of a premises includes a barrier section 12 having a plurality of vertically standing support members 14 and a steel mesh 16 that extends between the support members 14 to prevent entry into the protected area. The barrier 10 also includes an opening 18 for making entry through the barrier 10 and a gate 20 for closing the opening 18. Gate 20 may be pivoted on hinges for rotatably closing against the opening 18 or may be slideable along wheels 21 that roll on the ground 22 for slideably closing the opening 18. To retain the gate 20 enclosed against the opening 18, a lock mortise 23 and lock cylinder 25 are fitted within an enclosure 24. The mortise 23 includes a latch 27 that engages a lock receiver 26 positioned along an edge of the barrier 12. Where the gate 20 pivots on hinges 22 the lock is a slam latch and the lock receiver 26 has a aperture therein into which the deadbolt or slam latch is received. If the gate 20 is slideable on rails, the lock is a hook latch and lock receiver 26 has a crossbar therein that is engaged by the hook of the latch to prevent the gate 20 from being retracted along the rails.

To avoid failure of the lock as a result of tampering, the enclosure 24 is made of a strong material, such as metal, and has sufficient thickness and rigidity so as to resist being deformed or disassembled by an invading tool or by brute force. Also, the enclosure 24 has an exterior shape that mates with the exterior shape of the lock receiver 26 such that surfaces of each obstruct the insertion of a tool or other device between the lock and the receiver 26 to disengage the slam latch or hook latch such that the gate 20 can be opened. Failure of the enclosure 24 can therefore result in failure of the barrier 10 and accordingly it is desirable that the enclosure 24 be sufficiently strong to fully protect the lock therein.

Referring to FIGS. 1, 2, 3, and 10, the enclosure 24 is depicted as being in the same orientation as that depicted in FIG. 1, and for the purposes of the following discussion the parts shall be described as having upward portions that are directed to the top of the gate 20, lower portions that are directed toward the bottom of the gate 20, forward portions that are directed toward the lock receiver 26, and rearward portions that are directed away from the lock receiver 26.

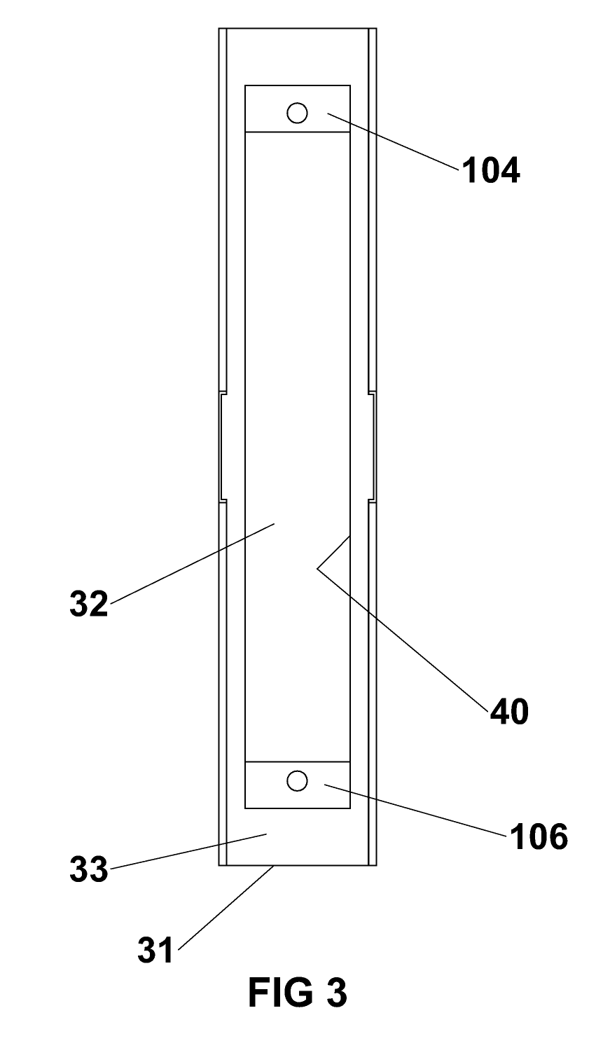

Accordingly, the enclosure 24 has large parallel opposing side surfaces 28, 29 and upper and lower surfaces 30, 31. The enclosure 24 also has a rear surface 32, best shown in FIG. 3, and a forward surface 33 having an opening 40 therein for receiving the mortise 23 and the faceplate 42 that extend across the forward surface of the mortise 23. To ensure that the enclosure 24 is adequately strong to protect the lock mortise 23 therein against the use of brute force, the various surfaces 28-33 are preferably made of panels of at least 1/16 inch high grade steel or its equivalent.

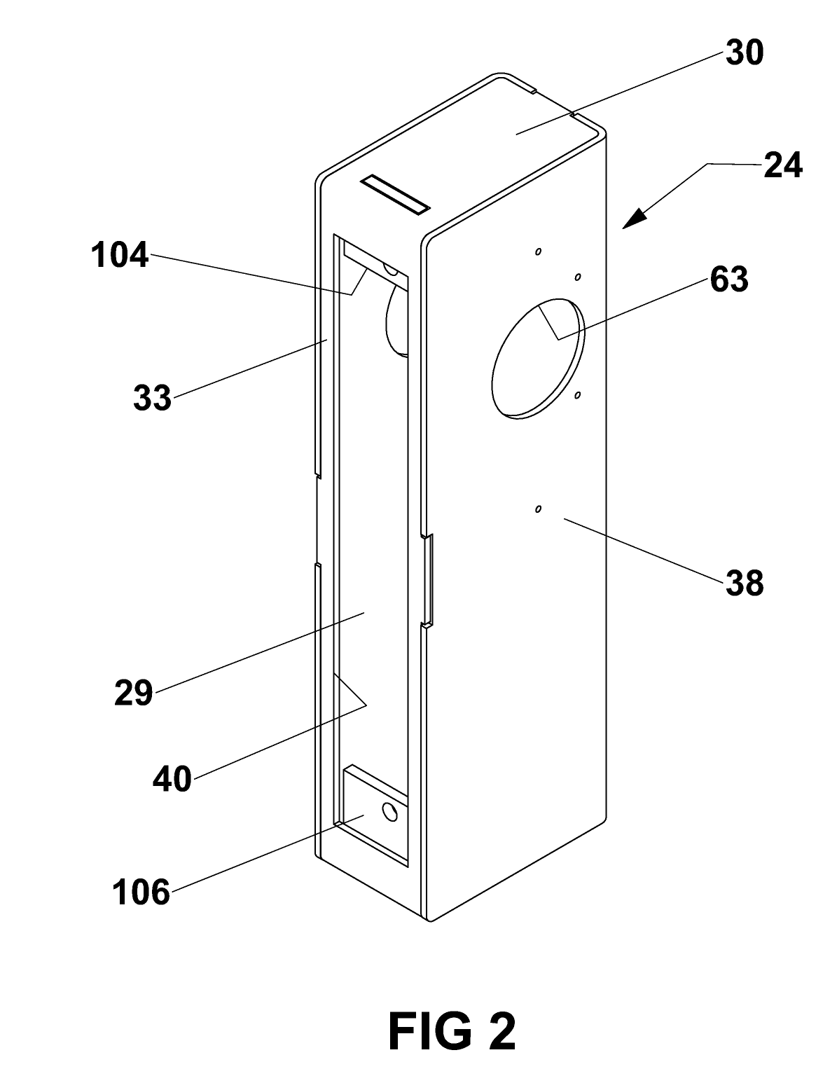

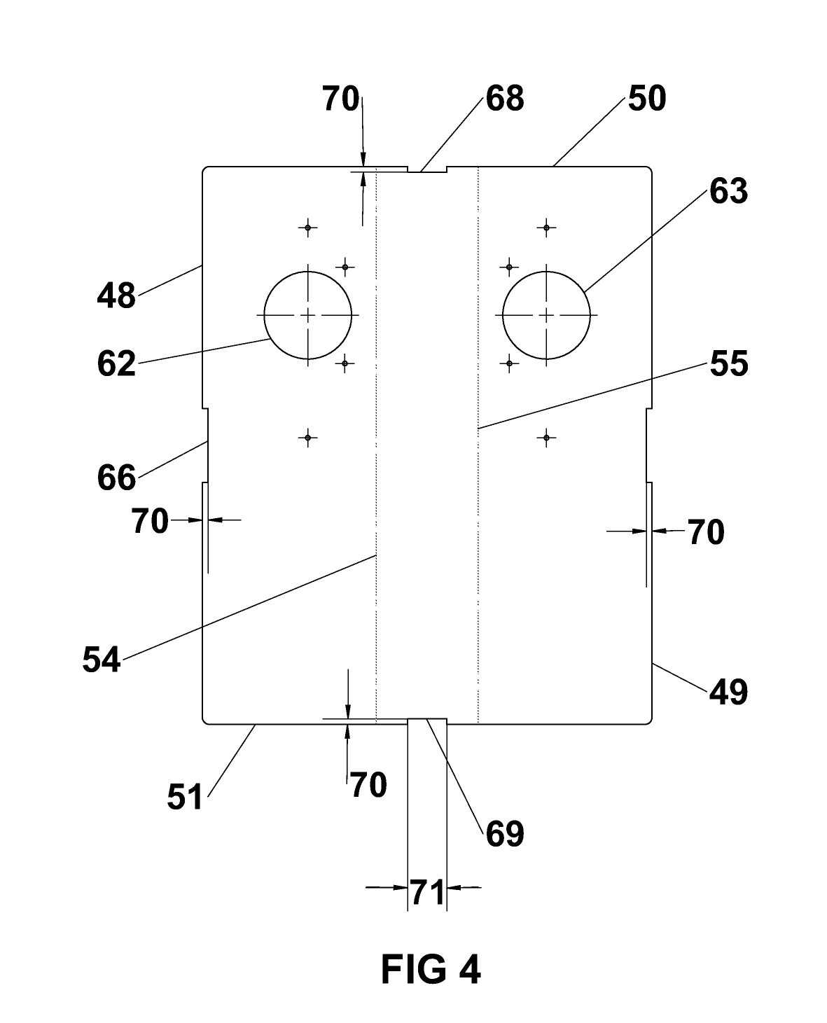

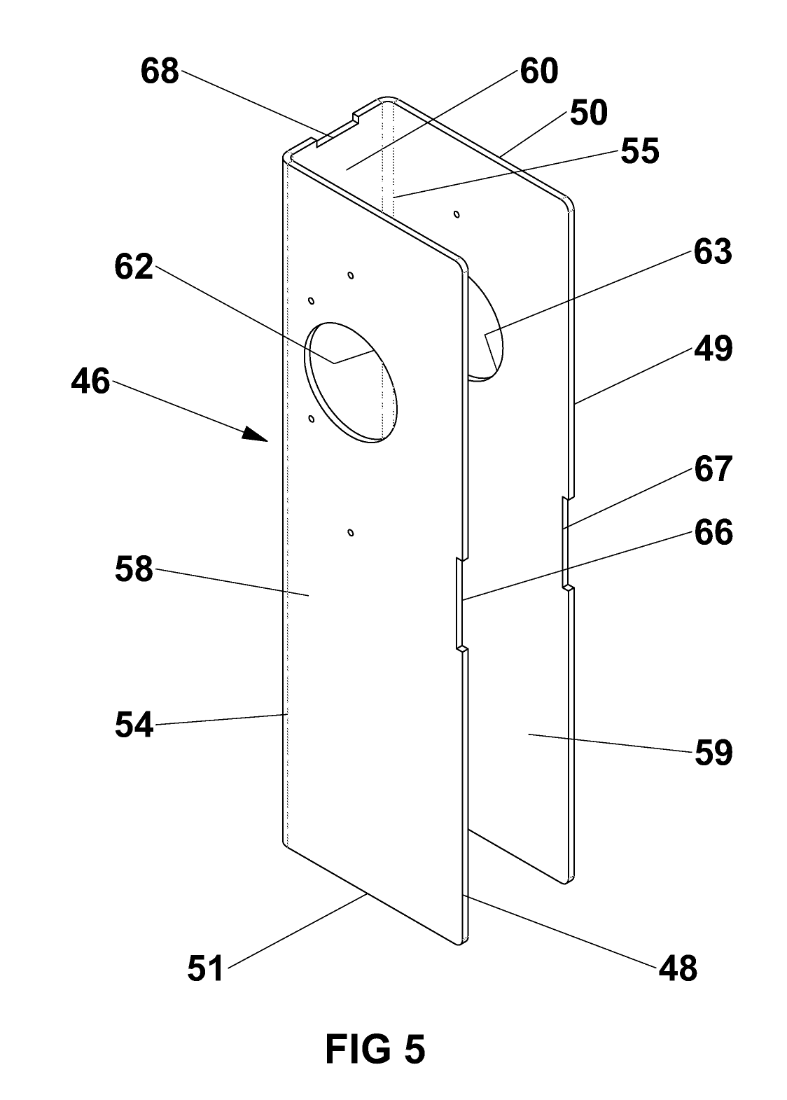

Referring to FIGS. 2 through 5 and 10, the enclosure 24 is formed from the assembly of preshaped metal cutout panels including a first panel 46 having parallel vertical edges 48, 49 and spaced apart horizontal edges 50, 51 that are perpendicular to the vertical edges 48, 49. Extending perpendicularly between the horizontal edges 50, 51 and parallel to the vertical edges 48, 49 are spaced apart parallel folds 54, 55 that divide the first panel 46 into three attached panel portions, including outer portions 58, 59 and between the outer portions a central portion 60. At the fold lines 54, 55 the panel 46 is folded with the outer portion 58, 60 oriented at ninety degrees to the central portion 60 such that outer portion 58 is spaced parallel to outer portion 59. Also, the panel 46 has a pair of circular apertures 62, 63 therein, with the first aperture 62 positioned near the upper end of the outer portion 58 and the second aperture 63 positioned in the upper end of outer portion 59 such that the two apertures 60, 63 are axially aligned with one another when the outer portions 58, 59 are folded about fold lines 54, 55 as depicted in FIG. 5. The diameters of the apertures 62, 63 are equal to the diameter of the lock cylinder 25 associated with the mortise 23 of the lock to be retained in the enclosure 24 and the apertures 62, 63 are positioned to receive the lock cylinder 25 when the mortise 23 is received in the opening 40 in the forward surface 33 of the enclosure 24.

The first panel 46 also has a plurality of notches 66,67, 68, 69 around the edge thereof with each of the notches centrally positioned along one of the edges 48, 49, 50, 51 thereof. Each of the notches 66-69 is a cutout from the associated panel portion 58, 59, 60 having a depth 70 that is approximately equal to the thickness of the metal from which the first panel 46 is formed. Notches 68 and 69 are positioned opposite each other and the widths 71 of each are equal to each other. Similarly, notches 66 and 67 are opposite each other and the widths 73 of each are equal to each other. When the panel 46 is folded along fold lines 54, 55, two of the notches 66, 67 are positioned along parallel spaced apart free edges 48, 49 of the outer portion 58, 59 and the remaining two notches 68, 69 are at opposite ends of the central portion 60.

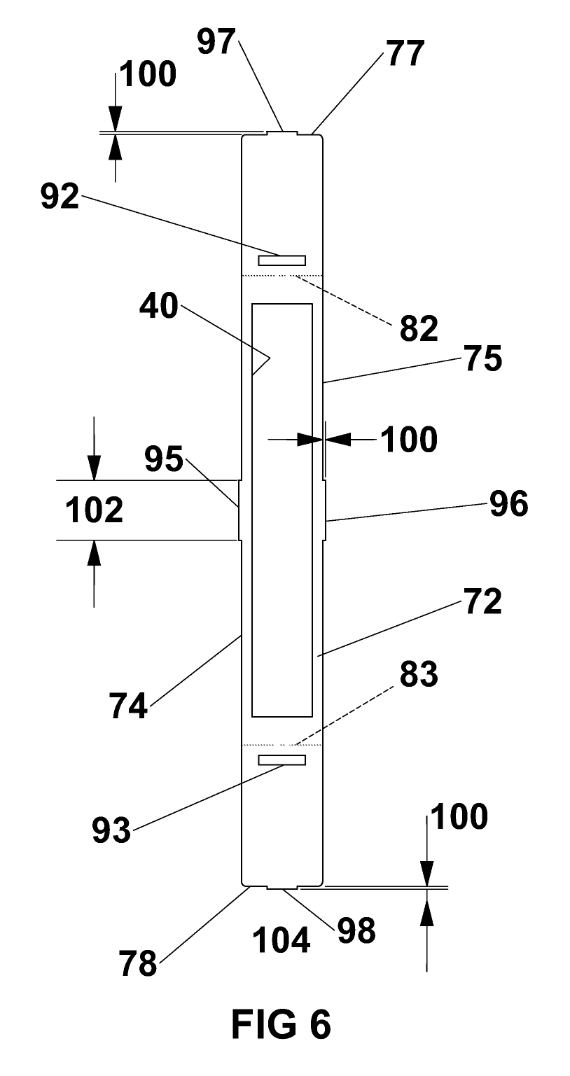

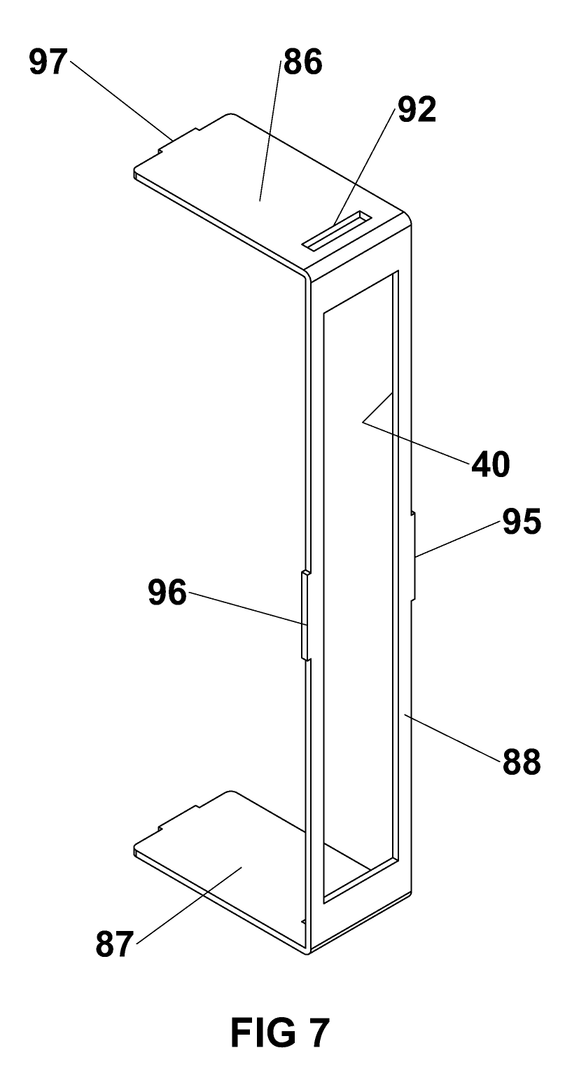

Referring to FIGS. 6, 7, and 10, the enclosure 24 also includes a second panel 72 having spaced apart parallel vertical edges 74, 75 and extending perpendicular to the vertical edges, spaced apart parallel upper and lower edges 77, 78. Positioned a short distance below the upper edge 77 is a first fold line 82 and positioned a short distance above the lower edge 78 is a second fold line 83, where the fold lines 82, 83 are adapted to be folded at ninety degrees such that the panel 72 is configured into an upper horizontal panel 86 and a lower horizontal panel 87, which are parallel to each other and extend from upper and lower ends of a vertical central panel 88. The central panel 88 has a central opening 40 therein sized to receive the faceplate 42 of a lock mortise 23.

Positioned a short distance above the upper fold line 82 is an elongate slot 92 oriented parallel to the upper fold line 82, and extending parallel to and spaced a short distance below the lower fold line 83 is a second slot 93 oriented parallel to fold line 83. With the panel 72 folded along the fold lines 82, 83, the first slot 92 is positioned in the upper panel 86 and extended parallel to the fold 82 joining the upper panel 86 with the central panel 88. Similarly, slot 93 is positioned in the lower panel 87 and parallel to the fold 83 joining the lower panel 87 to the central panel 88.

Extending along each of the outer edges 74-77 and positioned midway along the length of each of such edges is a tab 95, 96, 97, 98. Each of the tabs 95-98 has an overall length 100 equal to the thickness of the metal of which the first panel 46. Tabs 95 and 96 are positioned opposite each other and have widths 102 that are equal to each other and equal to the width 73 of notches 66 and 67 in panel 46. Similarly, tabs 97 and 98 are opposite each other, have widths 104 that are equal to each other, and equal to the width 71 of notches 68, 69.

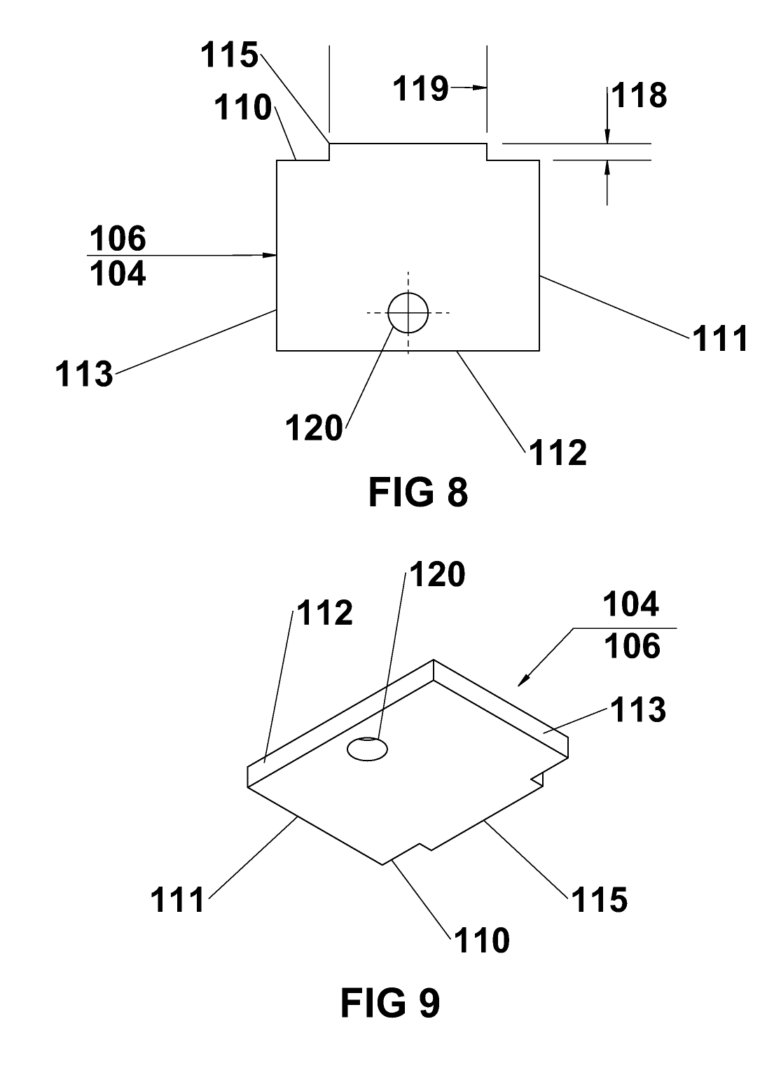

Referring to FIGS. 2, 3, 8, 9, and 10, the enclosure 24 further includes a pair of identical, generally rectangular mounting tabs 104, 106 each of which has four sides 110, 111, 112, 113 with a tab 115 positioned along one side 110. The tab 115 has a length 118 equal to the thickness of the metal of which the panel 72 is made and a width 119 equal to the width of one of the slots 92, 93. The mounting tabs 104, 106 are preferably made of steel having a thickness a little greater than the thickness of the first and second panels 46, 72. Each panel also has, positioned near one of the longer sides 112 thereof, a transverse hole 120 having threadings therein for receiving a retaining screw for retaining one end of a latch mortise 23 thereto.

Referring to FIGS. 2, 3, 5, 7, and 9, to form the enclosure 24 the tabs 115 of mounting tabs 104, 106 are first welded into the slots 92, 93 in the upper and lower panels 86, 87 of panel 72, with the tabs 115 directed toward each other and parallel to the vertical central panel 88. Thereafter, the folded second panel 72 is assembled to the folded first panel 46 with each of the tabs 95-98 on panel 72 received in one of the notches 66-69 of the first panel 46 such that the upper and lower panels 86, 87 of panel 72 form the upper and lower surfaces 30, 31 of the enclosure 24 and central panel 88 of second panel 72 forms the front surface 33 of the enclosure 24. Similarly, the parallel outer portions 58, 59 of first panel 46 form side surfaces 28, 29 and the central panel 60 of panel 46 forms the rear surface 32 of the enclosure 24.

It should be appreciated that an important feature of the invention is that the width of the tabs 95-98 are equal to the width of the associated notches 66, 69 such that each tab 95-98 is tightly received in its associated notch 66-69. With the tabs 95-98 of the second panel 72 fitted tightly into the notches 66-69 of the first panel 46, the two panels 46, 72 that make up the enclosure 72 will be retained together in their proper alignment without any portion thereof being askew or misaligned. Where the various folds 54, 55, 82, 83 form sharp ninety degree angles, the edges of the first panel 46 will then abut flush against the adjacent edges of the second panel 72 without gaps or discernable lines of separation. The tabs 95-98 tightly fitted into the notches 66-69 will retain the parts together such that they can be spot welded together locking them in their desired alignment.

Once the various parts of the enclosure 24 are fitted together, all the tabs 95-98 are welded into their associated notches 66-69 with the contact edges between each tab and notch welded continuously, without interruptions, along all the edges thereof such that the enclosure 24 constitutes a metal container with no visible openings except apertures 62, 63, 40 each of which is adapted to receive a portion of the mortise 23 and its associated parts. Once the panels 46, 72 have been welded together, the various exterior corners and edges are ground, machined, and polished. When completed, the enclosure 24 will have no visual or otherwise distinguishable division line between an edge of a first panel 46 and an edge of the second panel 72 such that a tampering tool cannot be fitted between abutting edges of the panels 46, 72 to compromise the lock enclosed therein.

Referring to FIGS. 1 and 10, when the lock mortise 23 and faceplate 42 are assembled into the enclosure 24 and the lock cylinder 25 is inserted, the parts of the mortise 23 and faceplate 42 fit within the openings 66, 63, 40 of the enclosure 24 such that contaminants and tampering tools cannot reach the workings of the mortise 23 within the enclosure 24. The enclosure 24 can thereafter be mounted on a gate 20 and a lock within the enclosure 24 can engage a lock receiver 26 and provide a safe lock for gate 20 of a barrier 10.

While the present invention has been described with respect to a single embodiment, it will be appreciated that many modifications and variations can be made without departing from the spirit and scope of the invention. It is therefore the intent of the appended claims to cover all such modifications and variations that fall within the spirit and scope of the invention.

What is claimed:

1. An enclosure for a lock mortise comprising
a first and a second metal panel having folds therein and fitted together to provide parallel opposing side surfaces,
parallel opposing upper and lower surfaces,
a rear surface, and
a forward opening for receiving said mortise, wherein
an intersection of a side of said first panel with a side of said second panel includes a notch in an edge of said first panel and a tab on an edge of said second panel.

2. An enclosure for a lock mortise comprising
a first rectangular metal panel having first and second parallel edges and third and fourth edges parallel to each other and perpendicular to said first and second edges,
said first panel having first and second right angle folds extending parallel to said first and second edges dividing said first panel into three panel portions in a U-shaped configuration,
a second rectangular metal panel having parallel outer edges and parallel ends perpendicular to said outer edges,
said second panel having a right angle fold extending parallel to said first and second edges dividing said second panel into panel portions, and
a tab along one of said edges of said first panel and a notch along one of said edges of said second panel and said tab received in said notch for retaining said panels together.

3. The enclosure of claim 2 and further comprising a second right angle fold in said second panel, said second fold parallel to said first fold dividing said second panel into three panel portions in a U-shaped configuration.

4. An enclosure for a lock mortise comprising
a first side panel and a parallel spaced apart second side panel,
each of said first and second side panels having first and second parallel sides and first and second parallel ends,
said first panel having first and second right angle folds extending parallel to said first and second edges dividing said first panel into three panel portions in a U-shaped configuration,
a tab on each of said first and second edges of said first panel,
a second rectangular metal panel having parallel outer edges and parallel ends perpendicular to said outer edges,
said second panel having first and second right angle folds extending parallel to said first and second edges dividing said second panel into three panel portions in a U-shaped configuration,
a notch in each of said parallel outer edges of said second panel,
said tabs of said first panel inserted into said notches of said second panel to retain said first and second panels together, and
a weld around an edge of one of said tabs and an adjoining one of said notches.

5. The enclosure of claim 4 and further comprising
a tab on each of said third and fourth edges of said first panel,
a notch in each of said parallel ends of said second panel, and
said tabs on said third and fourth edges of said first panel inserted into said notches in said ends of said second panel, and
a weld around edges of one of said tabs and an adjoining one of said notches.
